(19) United States
(12) Patent Application Publication
(10) Pub. No.: US 2010/0043004 A1
(43) Pub. Date: Feb. 18, 2010

(54) METHOD AND SYSTEM FOR COMPUTER SYSTEM DIAGNOSTIC SCHEDULING USING SERVICE LEVEL OBJECTIVES

(76) Inventors: Ashwini Kumar Tambi, Bangalore (IN); Archana Jagadish, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/236,514

(22) Filed: Sep. 24, 2008

(30) Foreign Application Priority Data
Aug. 12, 2008 (IN) 1939/CHE/2008

(51) Int. Cl. G06F 9/46

(52) U.S. Cl. 718/103; 718/104

(57) ABSTRACT

A system and method for automatically scheduling health diagnostics within a computer system is disclosed. In one embodiment, a method for automatically scheduling health diagnostics within a computer system using service level objectives (SLOs) includes reviewing the SLOs associated with each managed server, invoking each managed server for diagnosing computer system based on the associated SLOs, receiving diagnostic status data and computer system health data from each managed server, and analyzing the received diagnostic status data and computer system health data and implementing any needed one or more corrective actions based on the analysis and a predetermined configuration corrective action criteria.

### RELATED APPLICATIONS

Benefit is claimed under 35 U.S.C. 119(a)-(d) to Foreign application Ser No. 1939/CHE/2008 entitled “METHOD AND SYSTEM FOR COMPUTER SYSTEM DIAGNOSTIC SCHEDULING USING SERVICE LEVEL OBJECTIVES” by Hewlett-Packard Development Company, L.P., filed on 12th Aug., 2008, which is herein incorporated in its entirety by reference for all purposes.

### BACKGROUND

It is a common practice to proactively perform diagnostic health check of computer system at periodic intervals. However, such diagnostic health check may demand large system resources, such as central processing unit (CPU) time, memory, bandwidth via network and so on. This can have a significant negative impact on business application performance and/or can substantially stall the execution of business applications.

One prior art solution for diagnosing describes performing an intelligent selective diagnosis using firmware logs. However, this technique is limited to performing diagnosis using only firmware logs. Another prior art solution runs self-test applications on low priority processes. Though such applications may consume less CPU time, they are not integrated and controlled by workload management solutions and cannot be run in environments driven by service level objectives (SLOs). Yet, there are other prior art solutions that are based on management tools. However, these management tools do not proactively perform diagnosis based on system performance, and hence, can significantly affect the business application performance.

Therefore, traditionally, such proactive diagnostic health check is ignored in favor of business application performance. This can have a significant impact on system up time.

### BRIEF DESCRIPTION OF THE DRAWINGS

Embodiments of the present invention are illustrated by way of examples and are not limited to the figures of the accompanying drawings, in which like references indicate similar elements and in which:

FIG. 1 shows a block diagram illustrating major components of an automated diagnostic task scheduling system that uses service level objectives (SLOs) according to one embodiment;

FIG. 2 shows a block diagram illustrating major components of an automated diagnostic task scheduling system that uses SLOs according to another embodiment;

FIG. 3 shows a process flow of automatically scheduling of health diagnostics within a computer system according to one embodiment; and

FIG. 4 shows a diagrammatic system view of a data processing system in which any of the embodiments disclosed herein may be performed according to one embodiment.

Other features of the present embodiments will be apparent from the accompanying drawings and from the detailed description that follows.

### DETAILED DESCRIPTION

A system and method for automatically scheduling health diagnostics within a computer system using service level objectives (SLOs) is disclosed. In the following description, for purposes of explanation, numerous specific details are set forth in order to provide a thorough understanding of the various embodiments. It will be evident, however, to one skilled in the art that the various embodiments may be practiced without these specific details.

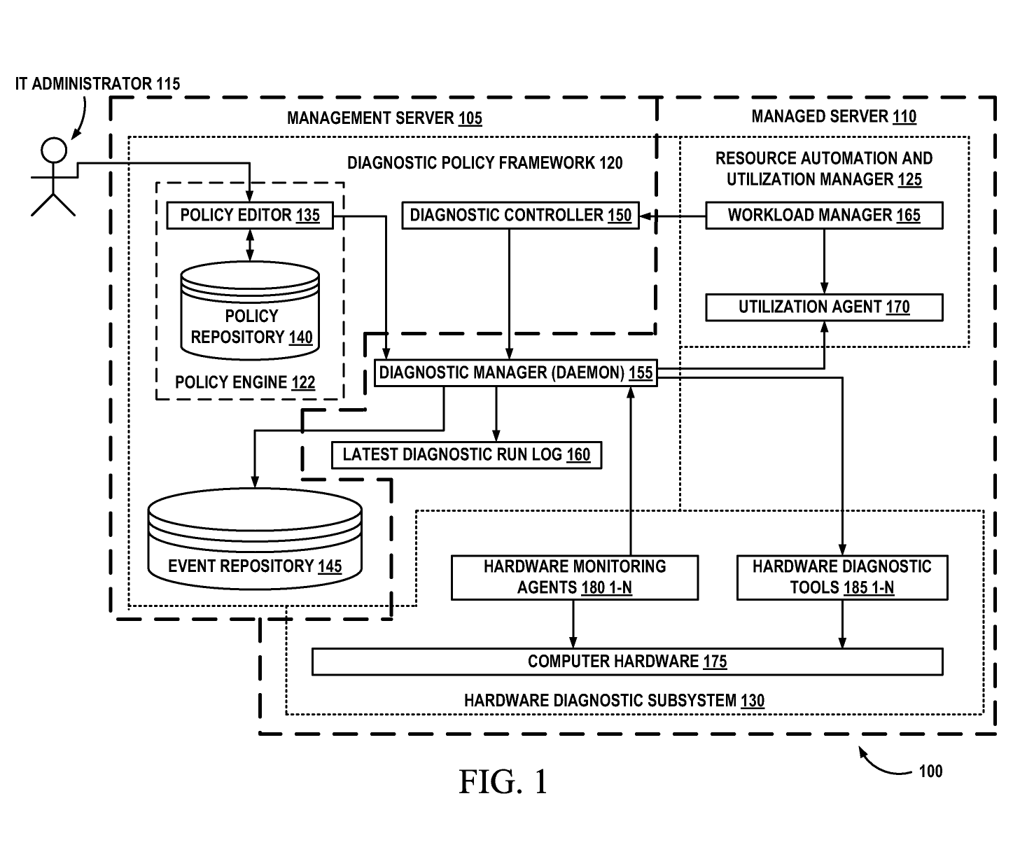

FIG. 1 shows a block diagram 100 illustrating major components of an automatic scheduling system, according to one embodiment, for performing diagnosis on hardware systems that uses SLOs. Particularly, FIG. 1 illustrates a management server 105 and a managed server 110. One can envision that the management server 105 can be communicatively coupled to one or more managed servers 110 via a local area network (LAN), the Internet, and the like communication links. As shown in FIG. 1, the management server 105 includes a portion of a diagnostic policy framework 120, which includes a policy engine 122, an event repository 145, and a diagnostic controller 150. Further as shown in FIG. 1, the policy engine 122 includes a policy editor 135, and a policy repository 140. Furthermore as shown in FIG. 1, the managed server 110 includes a remaining portion of the diagnostic policy framework 120, which includes a diagnostic manager (daemon) 155 and a latest diagnostic run log 160.

Also as shown in FIG. 1, the managed server 110 includes a resource automation and utilization manager 125 and a hardware diagnostic subsystem 130. In one embodiment, the diagnostic controller 150 is communicatively coupled to the resource automation and utilization manager 125. In addition as shown in FIG. 1, the resource automation and utilization manager 125 includes a workload manager 165 and a utilization agent 170. Further, the hardware diagnostic subsystem 130 includes computer hardware 175, a plurality of hardware monitoring agents 180 1-N and associated plurality of hardware diagnostic tools 185 1-N. Exemplary hardware diagnostic tools 185 1-N include a memory diagnostic tool, a central processing unit (CPU) diagnostic tool, and so on. Further, FIG. 1 also shows an IT administrator 115.

In operation, health diagnostics within the computer system are automatically scheduled using the SLOs. For example, the computer system includes the management server 105 communicatively coupled to the managed servers 110. In some embodiments, the SLOs for each managed server 110 are created by the IT administrator 115. In these embodiments, the SLOs for each managed server 110 are created using the policy editor 135 which is communicatively coupled to the policy repository 140. The policy repository 140 is a repository (e.g., a relational database management system (RDBMS), an extensible markup language (XML) file or any other suitable data store) that holds all the SLOs (which are user configurable). An exemplary policy repository 140 implemented as an XML file is illustrated in APPENDIX A.

In one embodiment, the SLOs are created based on parameters such as frequency at which each managed server 110 is invoked, when to invoke each managed server 110 based on a permissible system load and resource utilization information, events that can trigger invoking of diagnosing computer system, mode of notifying the received diagnostic status data and computer system health data.

In another embodiment, the IT administrator 115 modifies the one or more SLOs residing in the policy repository 140 using the policy editor 135. Typically, the policy editor 135 is a command line interface tool that facilitates the IT administrator 115 to modify the SLOs which are effective during current execution and/or also persistent across system reboot.

In operation, the diagnostic manager 155, which is coupled to the diagnostic controller 150, reviews the SLOs associated with each managed server 110. For example, the diagnostic manager 155 is a daemon, which performs analysis on the SLOs, scheduling and controlling (e.g. start, stop, suspend and resume) computer system diagnostics. Further, the diagnostic controller 150 may be a thin interface that supports four interface methods, namely, start, stop, suspend and resume and which forwards control requests to the diagnostic manager 155. The diagnostic controller 150 invokes the diagnostic manager 155 to perform hardware diagnosis on each managed server 110 based on the reviewed associated SLOs. In one embodiment, the diagnostic controller 150 invokes the diagnostic manager 155 via the associated plurality of hardware diagnostic tools 185 1-N to perform hardware diagnosis based on the associated SLOs. In this embodiment, the diagnostic manager 155 updates (e.g., when the hardware diagnostic tools 185 1-N start, stop, suspend or resume) the latest diagnostic run log 160 (which is communicatively coupled to the diagnostic manager 155). The latest diagnostic run log 160 is a log file (e.g., an XML based log file) and it includes an event associated with each invoking of the hardware diagnostic tools 185 1-N for diagnosing computer system. In one exemplary implementation, the hardware diagnostic tools 185 1-N are invoked to test (e.g., stress-test) the computer hardware 175 to detect any potential problem that may be arising going forward.

In one embodiment, the diagnostic manager 155 schedules execution of the hardware diagnostic tools 1851-N. In this embodiment, the diagnostic manager 155 may re-schedule execution of the associated hardware diagnostic tools 185 1-N if the associated SLOs are modified. In some embodiments, the diagnostic manager 155 can suspend the execution of the currently running hardware diagnostic tools 185 1-N, in which case, the diagnostic manager 155 saves the current state of execution in the latest diagnostic run log 160. When the execution of the hardware diagnostic tools 185 1-N is resumed, the diagnostic manager 155 reads the latest diagnostic run log 160 and continues the diagnosis from the point where it is suspended. This helps in improving operational efficiency of the computer system.

In some embodiments, the workload manager 165 determines resource utilization information associated with each managed server 110. In these embodiments, the utilization agent 170, coupled to the workload manager 165 and the diagnostic controller 150, analyzes the determined resource utilization information of each managed server 110 and determines a priority workload and a non-priority workload of each managed server 110. In one example embodiment, the utilization agent 170 analyzes the determined resource utilization information to provide separate resource utilization information for the priority workload and the non-priority workload. It should be noted that, the resource utilization information is divided into priority utilization data and non-priority utilization data. The priority utilization data indicates resource utilization by priority workloads, which are running on the computer system while the non-priority utilization data indicates the resource utilization by one or more non-priority workloads that are running on the computer system. Examples of the priority workload include a webserver, an ERP application, a billing application, and the like. Further, examples of the non-priority workload include proactive hardware health check, disk defragmentation, and the like.

It is appreciated that the utilization agent 170 determines the non-priority workload from a configuration file (i.e., defined by the IT administrator 115). For example, the configuration file includes names of the processes that are classified as non-priority workloads. Also, the configuration file may include a command for each process (that may be executed to terminate the process). An exemplary configuration file, including processes associated with the non-priority workloads, is illustrated in APPENDIX B.

In operation, the diagnostic manager 155 determines whether the determined resource utilization exceeds a predetermined resource utilization value for each managed server 110. In one embodiment, the diagnostic controller 150, using the diagnostic manager 155, suspends or stops one or more applications that are associated with the non-priority workload on each managed server 110 that is determined as exceeding the predetermined resource utilization value. It should be noted that the non-priority workload is not a part of the function of an application (e.g., a webserver, an ERP application, etc.) and hence, suspending or stopping the applications associating with the non-priority workload anytime by the diagnostic manager 155 allows additional priority workload (i.e., related to business applications) to be performed on the computer system. The priority workload is a part of the function of the application and hence cannot be suspended or stopped forcibly to reduce the resource utilization.

In another embodiment, the diagnostic manager 155 continues to receive diagnostic status data and computer system health data and determines the resource utilization information for each managed server 110 that is determined as not exceeding the predetermined resource utilization value after a predetermined time interval. Further, in an alternative embodiment, the diagnostic controller 150, using the diagnostic manager 155, defers the diagnosing computer system for each managed server 110 based on the associated SLOs if the determined resource utilization continues to exceed the predetermined resource utilization value after suspending/stopping the application(s) associated with the non-priority workload.

In some embodiments, the diagnostic manager 155 receives the diagnostic status data and computer system health data from each managed server 110. In these embodiments, the diagnostic controller 150 analyzes the received diagnostic status data and computer system health data and notifies the IT administrator 115 of any corrective action that needs to be implemented for each managed server 110 based on the analysis. In some embodiments, the IT administrator 115 implements the needed one or more corrective actions based on the analysis and a predetermined configuration corrective action criteria.

Further, in these embodiments, the event repository 145 coupled to the diagnostic manager 155 receives and stores the diagnostic status data and computer system health data associated with each managed server 110 via each associated hardware monitoring agent 180. It can be noted that, the hardware monitoring agents 180 1-N monitor (e.g., through reading the firmware logs) the computer hardware 175 and generate an event, whenever a fault in the computer hardware 175 is detected. In one exemplary implementation, each hardware monitoring agent 180 implements the desired algorithm for error threshold prior to the generation of the event. In one embodiment, the diagnostic manager 155 analyzes the event and executes one or more hardware diagnostic tools 185 1-N based on the SLOs.

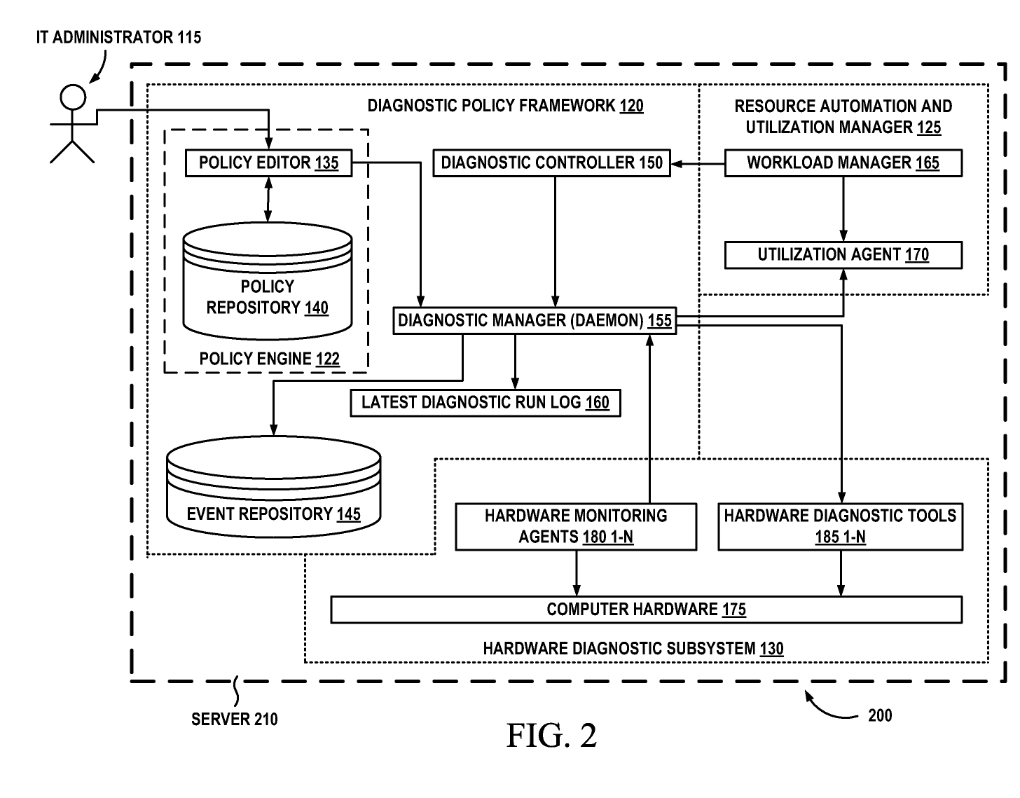

FIG. 2 shows a block diagram 200 illustrating major components of an automatic scheduling system, according to another embodiment, for performing diagnosis on hardware systems that uses SLOs. Particularly FIG. 2 illustrates the diagnostic policy framework 120 including the policy engine 122, the resource automation and utilization manager 125, and the hardware diagnostic subsystem 130 residing in a server 210, for instance, in a single managed server. One can envision that each server 210 can perform automatic scheduling of health diagnostics within the computer system, as all the components of the diagnostic policy framework 120 (including the policy engine 122) reside in the server 210 itself (and not in a management server, which can reside remotely from a managed server, such as the set up shown in FIG. 1).

As shown in FIG. 2, the policy engine 122 includes the policy editor 135 and the policy repository 140. Further as shown in FIG. 2, the diagnostic policy framework 120 includes the event repository 145, the diagnostic controller 150, the diagnostic manager (daemon) 155 and the latest diagnostic run log 160. Further, as shown in FIG. 2, the resource automation and utilization manager 125 includes the workload manager 165 and the utilization agent 170. In addition, the hardware diagnostic subsystem 130 includes the computer hardware 175, the plurality of hardware monitoring agents 180 1-N and the associated plurality of hardware diagnostic tools 185 1-N.

In operation, the health diagnostics within the computer system are automatically scheduled using the SLOs. In some embodiments, the SLOs for the server 210 are created by the IT administrator 115. In these embodiments, the SLOs for the server 210 are created using the policy editor 135, which is communicatively coupled, to the policy repository 140. In one embodiment, the SLOs are created based on parameters, such as frequency, at which the server 210 is invoked, when to invoke the server 210 based on a permissible system load and resource utilization information, events that can trigger invoking of diagnosing computer system, mode of notifying the received diagnostic status data and computer system health data. In another embodiment, the IT administrator 115 modifies the one or more SLOs residing in the policy repository 140 using the policy editor 135.

In operation, the diagnostic manager 155, which is coupled to the diagnostic controller 150, reviews the SLOs associated with the server 210. The diagnostic controller 150 invokes the diagnostic manager 155 to perform hardware diagnosis on the server 210 based on the reviewed associated SLOs. In one embodiment, the diagnostic controller 150 invokes the diagnostic manager 155 via the associated plurality of hardware diagnostic tools 185 1-N to perform hardware diagnosis based on the associated SLOs. In this embodiment, the diagnostic manager 155 updates (e.g., when the hardware diagnostic tools 185 1-N start, stop, suspend or resume) the latest diagnostic run log 160 (which is communicatively coupled to the diagnostic manager 155). The latest diagnostic run log 160 is a log file (e.g., an XML based log file) and it includes an event, associated with each invoking of the hardware diagnostic tools 185 1-N for diagnosing computer system.

In some embodiments, the workload manager 165 determines resource utilization information associated with the server 210. In these embodiments, the utilization agent 170, which is coupled to the workload manager 165 and the diagnostic controller 150, analyzes the determined resource utilization information of the server 210 and determines priority and non-priority workloads of the server 210. In some embodiments, the diagnostic manager 155 determines whether the determined resource utilization exceeds a predetermined resource utilization value for the server 210. In one embodiment, the diagnostic controller 150, using the diagnostic manager 155, suspends/stops applications that are associated with the non-priority workload on the server 210 that is determined as exceeding the predetermined resource utilization value.

In another embodiment, the diagnostic manager 155 continues to receive diagnostic status data and computer system health data and determines the resource utilization information that is determined as not exceeding the predetermined resource utilization value, after a predetermined time interval. Further, in an alternative embodiment, the diagnostic controller 150, using the diagnostic manager 155, defers the diagnosing computer system for the server 210 based on the associated SLOs, if the determined resource utilization information continues to exceed the predetermined resource utilization value after suspending/stopping the application(s) associated with the non-priority workload.

In some embodiments, the diagnostic manager 155 receives diagnostic status data and computer system health data from the server 210. In these embodiments, the diagnostic controller 150 analyzes the received diagnostic status data and computer system health data and notifies the IT administrator 115 of any corrective action that needs to be implemented for the server 210, based on the analysis and predetermined configuration corrective action criteria. Further, in these embodiments, the event repository 145 receives and stores the diagnostic status data and computer system health data associated with the server 210 via each associated hardware monitoring agent 180. The operations of the diagnostic policy framework 120, the resource automation and utilization manager 125, and the hardware diagnostic subsystem 130 are as explained in the foregoing with reference to FIG. 1.

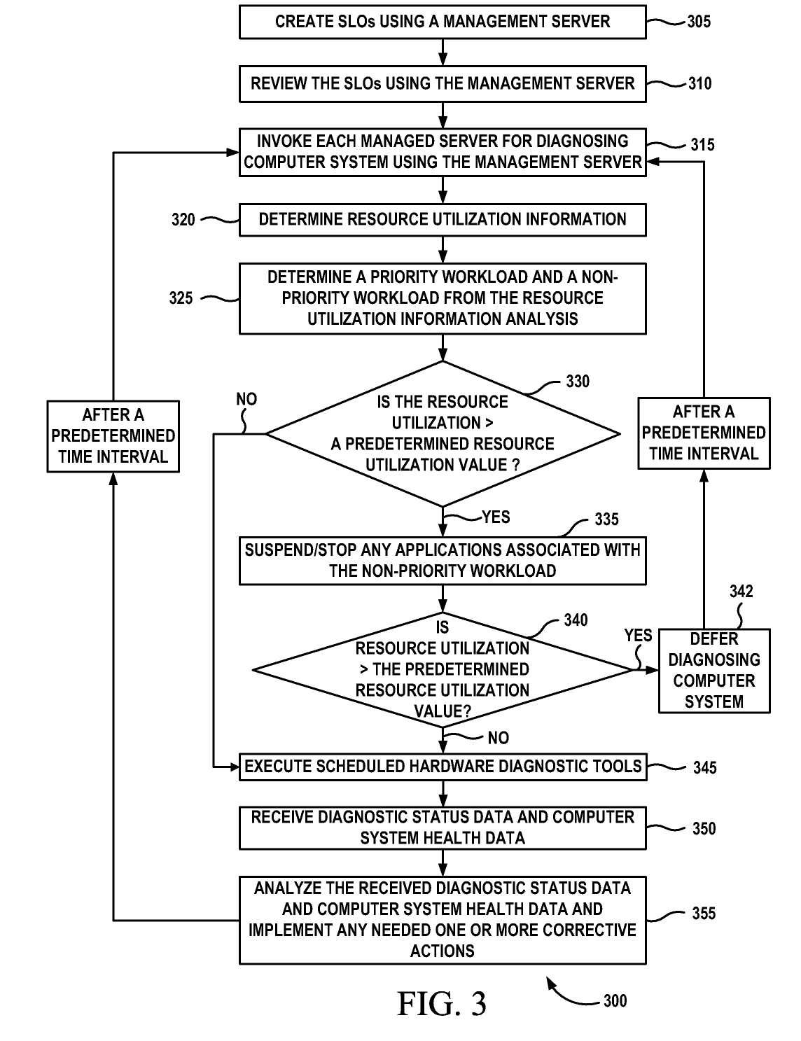

FIG. 3 shows a process flow 300 of automatically scheduling health diagnostics within a computer system, according to one embodiment. In some embodiments, the computer system is diagnosed using SLOs, which is a proactively diagnosing method that prevents any failure that might occur in the future. In these embodiments, the health diagnostics within the computer system are automatically scheduled using SLOs.

In operation 305, the SLOs are created by an IT administrator 115 using the management server 105 for each managed server 110. For example, the SLOs are created using parameters, such as frequency at which each managed server 110 is invoked, when to invoke based on permissible system load and resource utilization information, events that can trigger invoking of diagnosing computer system, and mode of notifying received diagnostic status data and computer system health data.

In operation 310, the SLOs associated with each managed server 110 are reviewed using the management server 105. In operation 315, diagnosing computer system is invoked in each managed server 110 based on the associated SLOs by the management server 105. In operation 320, resource utilization information associated with each managed server 110 is determined (e.g., by the workload manager 165). In some embodiments, the determined resource utilization information for each managed server 110 is analyzed. In operation 325, a priority workload and a non-priority workload for each managed server 110 are determined (e.g., by the utilization agent 170) based on the analysis performed.

In operation 330, it is determined whether the determined resource utilization is greater than a predetermined resource utilization value for each managed server 110. If it is determined that the resource utilization exceeds the predetermined resource utilization value, then in operation 335, any applications associated with the non-priority workload running on each managed server 110 are suspended/stopped, else the process 300 goes to operation 345.

After suspending/stopping any applications associated with the non-priority workload for each managed server 110 in operation 335, the process 300 determines whether the resource utilization is greater than the predetermined resource utilization value in operation 340. If the determination made in operation 340 is true, then the process 300 defers diagnosing computer system for each managed server 110 based on the associated SLOs in operation 342, otherwise, the process 300 performs operation 345.

In operation 345, scheduled hardware diagnostic tools 185 1-N are executed. In operation 350, the diagnostic status data and computer system health data for each managed server 110 are received by the diagnostic manager 155. In alternative embodiments, the diagnostic status data and computer system health data associated with each managed server 110 are received, for instance, via the hardware monitoring agent 180 and are stored in the event repository 145. In operation 355, the received diagnostic status data and computer system health data are analyzed by the management server 105 and any needed one or more corrective actions are implemented based on the analysis.

In other embodiments, in operation 355, the received diagnostic status data and computer system health data are analyzed and the needed one or more corrective actions are implemented based on the analysis and a predetermined configuration corrective action criteria. In these embodiments, the process 300 determines if there is any problem with the computer hardware 175 associated with each managed server 110 based on the received diagnostic status data and computer system health data. If any problem in the computer hardware 175 exists, then one or more corrective actions are determined and applied to alleviate the problem. For example, the one or more corrective actions can be as simple as mapping of errors to the one or more corrective actions or correlating any found hardware problems to a historical data and identify one or more corrective actions accordingly. In some embodiments, after determining one or more corrective actions, a user set configuration value is checked to see if the automatic corrective action is enabled or not. If the automatic corrective action is enabled, then the determined one or more corrective actions are implemented. If the automatic corrective action is not enabled, then the recommended one or more corrective actions are logged in latest the log file and no action is taken.

In an embodiment, the process 300 is routed back to operation 315 after performing operation 342 or operation 355 to invoke the diagnosing computer system, using the management server 105 after a predetermined time interval. The process 300 then repeats operations 315 to 355. In some embodiments, one or more of the SLOs are modified by the IT administrator 115 using the management server 105. In these embodiments, each managed server 110 is invoked by the management server 105 to perform hardware diagnosis after the predetermined time interval based on the associated modified SLOs.

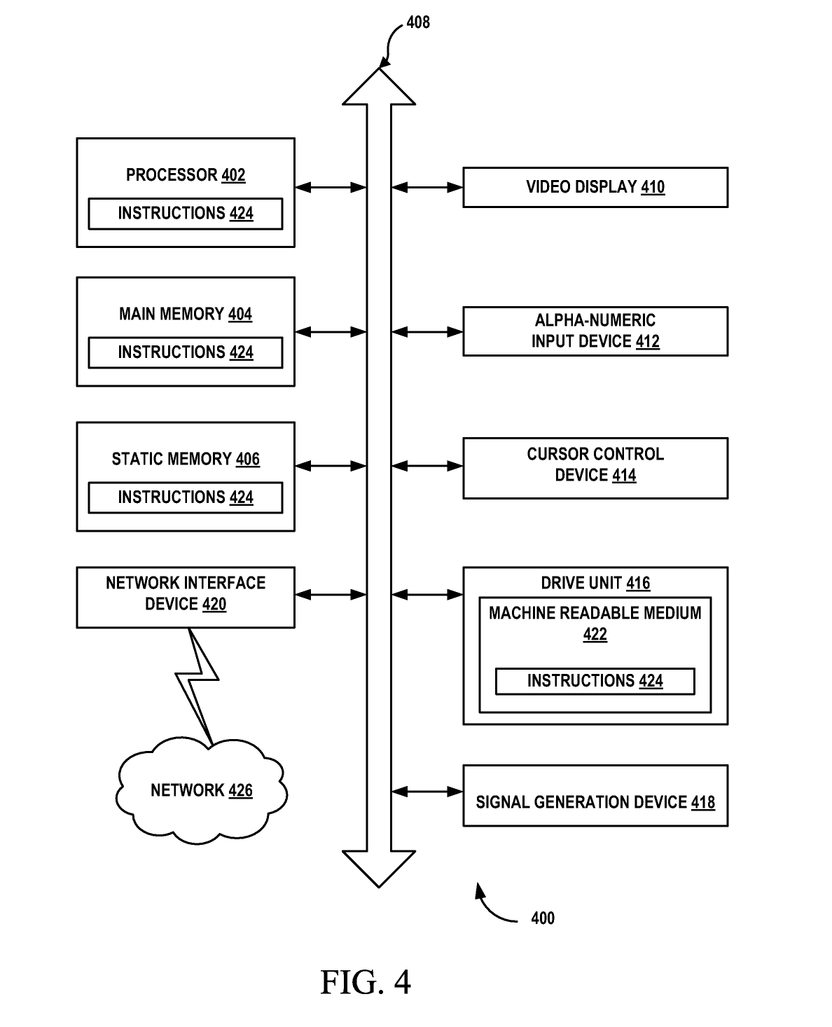

FIG. 4 shows a diagrammatic system view 400 of a data processing system in which any of the embodiments disclosed herein may be performed, according to one embodiment. Particularly, the diagrammatic system view 400 illustrates a processor 402, a main memory 404, a static memory 406, a bus 408, a video display 410, an alpha-numeric input device 412, a cursor control device 414, a drive unit 416, a signal generation device 418, a network interface device 420, a machine readable medium 422, instructions 424 and a network 426.

The diagrammatic system view 400 may indicate a personal computer and/or a data processing system in which one or more operations disclosed herein are performed. The processor 402 may be a microprocessor, a state machine, an application specific integrated circuit, a field programmable gate array, etc. The main memory 404 may be a dynamic random access memory and/or a primary memory of a computer system. The static memory 406 may be a hard drive, a flash drive, and/or other memory information associated with the data processing system.

The bus 408 may be an interconnection between various circuits and/or structures of the data processing system. The video display 410 may provide graphical representation of information on the data processing system. The alpha-numeric input device 412 may be a keypad, keyboard and/or any other input device of text (e.g., a special device to aid the physically handicapped). The cursor control device 414 may be a pointing device such as a mouse. The drive unit 416 may be a hard drive, a storage system, and/or other longer term storage subsystem.

The signal generation device 418 may be a BIOS and/or a functional operating system of the data processing system. The network interface device 420 may perform interface functions (e.g., code conversion, protocol conversion, and/or buffering) required for communications to and from the network 426 between a number of independent devices (e.g., of varying protocols). The machine readable medium 422 may provide instructions on which any of the methods disclosed herein may be performed. The instructions 424 may provide source code and/or data code to the processor 402 to enable any one or more operations disclosed herein.

For example, a storage medium having instructions, that when executed by a computing platform performs a method of automatically scheduling health diagnostics within a computer system using SLOs including reviewing the SLOs associated with each managed server 110 by the management server 105, invoking each managed server 110 for diagnosing computer system based on the associated SLOs by the management server 105, receiving diagnostic status data and computer system health data from each managed server 110, and analyzing the received diagnostic status data and computer system health data by the management server 105 and implementing one or more corrective actions based on the analysis and a predetermined configuration corrective action criteria. In some embodiments, the computer system includes a plurality of managed servers 110 communicatively coupled to the management server 105 (e.g., as illustrated in FIG. 1).

Further, the storage medium may have instructions to determine resource utilization information associated with each managed server 110, analyze the determined resource utilization information for each managed server 110 and determine a priority workload and a non-priority workload for each managed server 110 based on the analysis. Further, the storage medium may have instructions to determine whether the determined resource utilization exceeds a predetermined resource utilization value for each managed server 110, suspend/stop any applications associated with the non-priority workload running on each managed server 110 that is determined to have exceeded the predetermined resource utilization value, and if not, to continue receiving the diagnostic status data and computer system health data and determining the resource utilization information for each managed server 110 after a predetermined time interval.

The storage medium may also have instructions to determine whether resource utilization continues to exceed the predetermined resource utilization value after suspending/stopping any of the applications associated with the non-priority workload for each managed server 110. If the resource utilization continues to exceed the predetermined resource utilization value, the diagnosing computer system for each managed server 110 based on the associated SLOs is deferred, and if not, any scheduled hardware diagnostic tools 185 1-N are executed.

Furthermore, a computer system includes a processing unit and a memory coupled to the processor, the memory having code stored therein. The code, when decoded by the processor, causes the processor to perform a method including reviewing SLOs associated with each managed server 110 by the management server 105, invoking each managed server 110 for diagnosing computer system based on the associated SLOs by the management server 105, receiving diagnostic status data and computer system health data from each managed server 110, and analyzing the received diagnostic status data and computer system health data by the management server 105 and implementing one or more corrective action based on the analysis and a predetermined configuration corrective action criteria.

Even though the automatic hardware diagnostic system is explained in the foregoing with reference to FIG. 1 wherein a policy engine residing in the management server, one can envision that all the components of the policy engine can reside within a managed server so that each managed server has the capability to automatically monitor and diagnose the computer system independently.

The above-described technique enables system diagnostics to be controlled, based on system load and hardware events. Further, the above-described technique allows the computer system to be tuned based on user-defined SLOs. Furthermore, the above-described technique integrates system health diagnostics with workload management. Thus, it allows the workload manager to control computer system health diagnostics.

In addition, the above-described technique for hardware diagnostic health check can be performed without having to allocate any time for diagnosing computer system during a planned downtime and therefore, this technique significantly reduces system downtime. It can be seen that significant cost savings can be realized by minimizing the planned downtime. Moreover, proactive diagnosing of the health of a computer system ensures detecting potential problems well before their occurrence. This facilitates implementing proactive solutions, thereby, increasing computer system uptime and reliability. The above-described framework allows an IT administrator to tune the SLOs based on a desired workload profile without impacting on the computer system performance.

Although, the above technique is described with reference to automatically scheduling hardware health diagnostics within a computer system, one can envision that the above technique can be used for scheduling software health diagnostics also.

APPENDIX A is an exemplary policy repository (e.g., the policy repository 140 of FIGS. 1 and 2) which is implemented as an XML file.

APPENDIX B is an exemplary configuration file including processes associated with non-priority workloads.

Further, the foregoing described method may be in a form of a machine-readable medium embodying a set of instructions that, when executed by a machine, cause the machine to perform any method disclosed herein. It will be appreciated that the various embodiments discussed herein may not be the same embodiment, and may be grouped into various other embodiments not explicitly disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

```
APPENDIX A
<DiagPolicy>
  <Tool-List>  <!--List of diag tools: ID, Name and process name -->
      <Tool>
        <Tool-ID> 1 </Tool-ID>
        <Name> CPUDiagTool </Name>
      </Tool>
      <Tool>
        <Tool-ID> 2 </Tool-ID>
        <Name> MemDiagTool </Name>
      </Tool>
      <Tool>
        <Tool-ID> 3 </Tool-ID>
        <Name> DiskDiagTool </Name>
      </Tool>
  </Tool-List>
  <Scheduling> <!-- Frequency information related to scheduling of
diag tools execution -->
      <Tool>
        <Tool-ID> 1 </Tool-ID> <!-- As defined in the tag Tool-
      List above -->
        <Frequency> 2 </Frequency>
        <Freq-unit> WEEKS </Freq-unit>  <!-- The XML
schema defines the list of possible values: DAYS, WEEKS, MONTHS -->
      </Tool>
      <Tool>
        <Tool-ID> 2 </Tool-ID>
        <Frequency> 1 </Frequency>
        <Freq-unit> MONTHS </Freq-unit>
      </Tool>
      <Tool>
        <Tool-ID> 3 </Tool-ID>
        <Frequency> 2 </Frequency>
        <Freq-unit> MONTHS </Freq-unit>
      </Tool>
  </Scheduling>
  <Utilization>  <!-- Various Utilization parameters that define
  SLO -->
    <MaxStartupUtilization>  <!-- Diag tools execution can start only
when the utilization is below the specified value; more parameters can
be defined; one or more parameters can be omitted depending upon
the requirement -->
      <CPU> 20 </CPU>  <!-- Value indicates % CPU usage -->
      <Memory> 30 </Memory>  <!-- Value indicates % Memory
usage -->
    </MaxStartupUtilization>
    <UtilizationPolling>  <!-- Periodicity of checking
    Utilization data -->
      <NumberOfConsecutivePolls> 3 </NumberOfConsecutivePolls>
  <!-- Number of consecutive times utilization data should be below
  max value -->
      <PollingInterval> 1 </PollingInterval>
      <IntervalUnit> MIN </IntervalUnit>  <!-- The XML schema
defines the list of possible values: SEC, MIN, HOUR -->
    </UtilizationPolling>
  </Utilization>
  <Event-List> <!-- List of events that trigger execution of associated
diag tool -->
    <Event>
      <Event-ID> 100624 </Event-ID>
      <MonitorName> CPUMonitor </MonitorName>  <!--
Combination of Event ID and Monitor name uniquely identifies an
event -->
      <DiagToolID> 1 </DiagToolID> <!-- The Tool-ID as defined in
    the tag Tool-
List above -->
    </Event>
    <Event>
      <Event-ID> 293642 </Event-ID>
      <MonitorName> MemMonitor </MonitorName>
      <DiagToolID> 2 </DiagToolID>
    </Event>
    <Event>
      <Event-ID> 223965 </Event-ID>
      <MonitorName> DiskMonitor </MonitorName>
      <DiagToolID> 1 </DiagToolID>
      <DiagToolID> 3 </DiagToolID>
    </Event>
  </Event-List>
  <Notification>
    <Enabled>YES</Enabled>  <!-- Indicates whether notification is
enabled or not. -->
    <SMTPServer> a.b.c.d </SMTPServer> <!-- The IP address or
name of the SMTP server, wherein a.b.c.d. represents IP address -->
    <FromEmailAddress>auto-diag@hp.com</FromEmailAddress> <!--
Email address from which the email notification to be sent -->
    <ToEmailAddress>sysadmin@hp.com</ToEmailAddress> <!--
comma separated Email address(es) to which the notification to be sent-->
    </Notification>
</DiagPolicy>
```

```
APPENDIX B
<Non-priority Workload List>
  <Workload>
    <ID> 1 </ID>  <!-- A serial number to uniquely identify
the workload in this config file -->
    <Process> /home/archana/exampleWorkloadA
</Process>
    <Stop>  <!-- Defines how this workload can be stopped
-->
      <WBEM>  <!-- Stop this workload using the
specified WBEM CIM class and the interface method -->
        <Class> CIM_ExampleController </Class>
        <!-- The CIM class implemented by the WBEM provider --
      >
        <Method> stop </Method>
      </WBEM>
    </Stop>
  </Workload>
  <Workload>
    <ID> 2 </ID>
    <Process> /home/ashwini/bin/dummyLoadA </Process>
    <Stop>
      <Command> “/home/ashwini/bin/dummyLoadA -stop”
</Command> <!-- Use this command to stop this workload -->
    </Stop>
  </Workload>
  <Workload>  <!-- Absence of stop tag indicates that “kill -9
<pid>” can be used to stop this workload or any other equivalent
facility provided by the operating system on the computer system. -->
    <ID> 3 </ID>
    <Process> /home/ashwini/bin/dummyLoadB </Process>
  </Workload>
</Non-priority Workload List>
```

What is claimed is:

1. A method for automatically scheduling health diagnostics within a computer system using service level objectives (SLOs) and wherein the computer system includes a plurality of managed servers communicatively coupled to a management server, comprising:
creating the SLOs by an information technology (IT) administrator using the management server for each managed server;
reviewing service level objectives (SLOs) associated with each managed server by the management server; and
invoking each managed server for diagnosing the computer system based on the associated SLOs by the management server.

2. The method of claim 1, further comprising:
receiving diagnostic status data and computer system health data from each managed server;
analyzing the received diagnostic status data and computer system health data by the management server; and
implementing one or more corrective actions based on the analysis and a predetermined configuration corrective action criteria.

3. The method of claim 2, further comprising:
determining resource utilization information associated with each managed server;
analyzing the determined resource utilization information for each managed server; and
determining a priority workload and a non-priority workload for each managed server based on the analysis.

4. The method of claim 3, further comprising:
determining whether the determined resource utilization exceeds a predetermined resource utilization value for each managed server;
if so, suspending any applications associated with the non-priority workload running on each managed server that is determined to have exceeded the predetermined resource utilization value; and
if not, executing any scheduled hardware diagnostic tools and continuing receiving the diagnostic status data and computer system health data and determining the resource utilization information for each managed server after a predetermined time interval.

5. The method of claim 4, further comprising:
determining whether the resource utilization exceeds the predetermined resource utilization value after suspending any of the applications associated with the non-priority workload for each managed server;
if so, deferring the diagnosing computer system for each managed server based on the associated SLOs; and
if not, executing any scheduled hardware diagnostic tools and continuing receiving the diagnostic status data and computer system health data and determining resource utilization information for each managed server after a predetermined time interval.

6. The method of claim 1, further comprising:
modifying one or more of the SLOs by the IT administrator using the management server; and
invoking each managed server for diagnosing computer system based on the associated modified SLOs by the management server.

7. An article, comprising:
a storage medium having instructions, that when executed by a computing platform, results in execution of a method for automatically scheduling health diagnostics within a computer system using service level objectives (SLOs) and wherein the computer system includes a plurality of managed servers communicatively coupled to a management server, the method comprising:
reviewing service level objectives (SLOS) associated with each managed server by the management server;
invoking each managed server for diagnosing computer system based on the associated SLOs by the management server; and
receiving diagnostic status data and computer system health data from each managed server.

8. The article of claim 7, further comprising:
determining resource utilization information associated with each managed server;
analyzing the determined resource utilization information for each managed server;
determining a priority workload and a non-priority workload for each managed server based on the analysis;
determining whether the determined resource utilization exceeds a predetermined resource utilization value for each managed server;
if, so suspending any applications associated with the non-priority workload running on each managed server that is determined to have exceeded the predetermined resource utilization value; and
if not, executing any scheduled hardware diagnostic tools and continuing receiving the diagnostic status data and computer system data and determining the resource utilization information for each managed server after a predetermined time interval.

9. The article of claim 8, further comprising:
determining whether the resource utilization exceeds the predetermined resource utilization value after suspending any of the applications associated with the non-priority workload for each managed server;
if so, deferring the diagnosing computer system for each managed server based on the associated SLOs; and
if not, executing any scheduled hardware diagnostic tools and continuing receiving the diagnostic status data and computer system health data and determining resource utilization information for each managed server after a predetermined time interval.

10. A computer system comprising:
a plurality of managed servers; and
a management server communicatively coupled to the plurality of managed servers, wherein the management server includes a policy engine and a diagnostic controller and wherein each managed server comprises:
a resource automation and utilization manager;
a hardware diagnostic subsystem; and
a diagnostic manager, wherein the policy engine comprises a policy repository including service level objectives (SLOs), wherein the diagnostic manager reviews the SLOs associated with each managed server, and wherein the diagnostic controller invokes each managed server for diagnosing computer system based on the reviewed associated SLOs, wherein the diagnostic manager receives diagnostic status data and computer system health data from each managed server.

11. The computer system of claim 10, wherein the policy engine further comprises:
a policy editor, wherein the policy editor is coupled to the policy repository, and wherein the IT administrator creates the SLOs for each managed server using the policy editor.

12. The computer system of claim 11, wherein the resource automation and utilization manager comprises:
a workload manager to determine resource utilization information associated with each managed server; and
a utilization agent coupled to the workload manager and the diagnostic controller and wherein the utilization agent analyzes the determined resource utilization information of each managed server and determines a priority workload and a non-priority workload of each managed server.

13. The system of claim 12, wherein the diagnostic manager determines whether the determined resource utilization exceeds a predetermined resource utilization value for each managed server, wherein the diagnostic controller using the diagnostic manager suspends any applications that are associated with the non-priority workload running on each managed server that is determined as exceeding the predetermined resource utilization value, wherein the diagnostic manager continues receiving the diagnostic status data and computer system health data and determining the resource utilization information for each managed server that is determined as not exceeding the predetermined resource utilization value after a predetermined time interval.

14. The computer system of claim 13, wherein each managed server comprises:
a plurality of hardware monitoring agents and associated plurality of hardware diagnostic tools and wherein the diagnostic controller invokes the diagnostic manager via the associated plurality of hardware diagnostic tools for diagnosing computer system based on the associated SLOs.

15. The computer system of claim 14, wherein the managed server further comprises:
a latest diagnostic run log that is communicatively coupled to the diagnostic manager and wherein the latest diagnostic run log is an extensible markup language (XML) based log file including event associated with each invoking of the hardware diagnostic tools for diagnosing computer system that is updated by the diagnostic manager.

16. The computer system of claim 15, wherein the management server further comprises an event repository that is coupled to the diagnostic manager to receive and store the diagnostic status data and computer system health data associated with each managed server via each associated hardware monitoring agent, and wherein the IT administrator modifies the one or more SLOs residing in the policy repository using the policy editor.
